(19) United States
(12) Patent Application Publication
(10) Pub. No.: US 2003/0103080 A1
(43) Pub. Date: Jun. 5, 2003

(54) System and method for developing a code generator for object-oriented communication protocol

(76) Inventor: Bahman Radjabi, San Jose, CA (US)

Correspondence Address: FAY KAPLUN & MARCIN, LLP, 15O BROADWAY, SUITE 702, NEW YORK, NY, 10038, US

(21) Appl. No.: 10/007,510

(22) Filed: Dec. 5, 2001

(51) Int. Cl. G09G 5/00; G06F 9/44; G06F 15/173

(52) U.S. Cl. 345/763; 717/109; 717/113; 709/223

(57) ABSTRACT

A system and method is described for developing a code generator for object-oriented communication protocols. The system includes a code generation engine which automatically generates the necessary software code for communication between network devices as a function of network device profile data, network specification data and customized device data. Furthermore, receiving customized device data for a first device of a network via a graphical user interface is provided by a developer, generating a first software code for device objects of the first device and a second software code for a device linkage interface as a function of network device profile data, network specification data and the customized device data, and automatically generating a software code using the first and second software codes to allow communications between a first device and a second device of the network.

### BACKGROUND

As automation in the industrial and commercial sector have grown over the past years, there has been an increasing need for communication technology which allows the interchangeability of simple devices while making interconnectivity of more complex devices possible. In response to this need, object-oriented programming was implemented.

Object-oriented programming is a type of programming where developers define not only the data type of a data structure, but also the types of functions that the data structure may perform. It is organized around data rather than logic (i.e., objects rather than actions), and thus, the data becomes an object that includes both the data and functions. Developers often times use code generators to create the source code that reflects the behavior of these objects. Code generators allow developers to generate code for objects and the corresponding linkage system for object-oriented communication protocols.

### SUMMARY OF THE INVENTION

The present invention discloses a system and method for developing a code generator for object-oriented communication protocols. The system comprises a code generation engine which automatically generates software code as a function of network device profile data, network specification data and customized device data. The software code allows for communication between devices in a network.

The method involves receiving customized device data for a network device using a graphical user interface. Software code, which is a function of the network device profile data, the network specification data and the customized device data, is generated for device objects of a device and for a device linkage interface. Finally, the code generator automatically generates software code using the software codes to allow communication between two devices of a network.

### BRIEF DESCRIPTION OF DRAWINGS

FIG. 1 shows an exemplary embodiment of a network according to the present invention.

FIG. 2 shows an exemplary embodiment of a development environment.

FIG. 3 shows an exemplary embodiment of a method for generating code for communication between network devices according to the present invention.

FIG. 4 shows an exemplary embodiment of a method for implementing optional preferences for a required object.

FIG. 5 shows an exemplary embodiment of a method for loading an optional object.

FIG. 6A shows an exemplary embodiment of a method for loading required attributes.

FIG. 6B shows an exemplary embodiment of a method for loading optional attributes.

FIG. 6C shows an exemplary embodiment of a method for loading conditional attributes.

FIG. 7 shows an exemplary embodiment of a method for creating a linkage system.

FIG. 8A shows an exemplary screen shot of the Device Profile layer of a directory tree according to the present invention.

FIG. 8B shows an exemplary screen shot of the Objects layer of a directory tree according to the present invention.

FIG. 8C shows an exemplary screen shot of the Object A layer of a directory tree according to the present invention.

FIG. 8D shows an exemplary screen shot of the Class layer of a directory tree according to the present invention.

FIG. 8E shows an exemplary screen shot of the Attributes layer of a directory tree according to the present invention.

FIG. 8F shows an exemplary screen shot of the Attribute 1 layer of a directory tree according to the present invention.

FIG. 8G shows an exemplary screen shot of the Behavior layer of a directory tree according to the present invention.

FIG. 8H shows an exemplary screen shot of the States layer of a directory tree according to the present invention.

FIG. 9A shows an exemplary screen shot of a Q&A session prompting the developer to select a protocol.

FIG. 9B shows an exemplary screen shot of a Q&A session prompting the developer to select a device profile.

FIG. 9C shows an exemplary screen shot of a Q&A session prompting the developer to view the required object(s) and select any optional object(s).

FIG. 9D shows an exemplary screen shot of a Q&A session prompting the developer to select optional class attribute(s) and class service(s) for Object A.

FIG. 9E shows an exemplary screen shot of a Q&A session prompting the developer to select the number of instances and optional instance attribute(s) and service(s).

### DETAILED DESCRIPTION

The present invention may be further understood with reference to the following description of preferred exemplary embodiments and the related appended drawings, wherein like elements are provided with the same reference numerals.

A communication network is a plurality of network devices that transfers information through a connectivity link. The way information flows on a communication network is critical. For a network to be effective, it may have the capability of inter-network device communication and communicating with non-network data sources. In order for the communication network to communicate efficiently, it may use a common language and provide interfaces or gateways between the network devices and/or between the devices and a non-network data sources, or adhere to a common protocol.

A communication protocol is an agreed-upon format for transmitting data between devices and is used to categorize different types of networks. There are a variety of standard protocols from which developers may choose. One such protocol is administered by the Open DeviceNet Vendor Association (ODVA) and is commonly referred to as “DeviceNet.” The protocol defines a common set of rules and signals that the devices on the network implement in order to communicate with each other. The protocol may determine the type of error checking to be used, the data compression method, the method in which the sending device indicates the completion of sending a message, and the method in which the receiving device indicates the completion of receiving a message. A protocol may be implemented in hardware and/or in software.

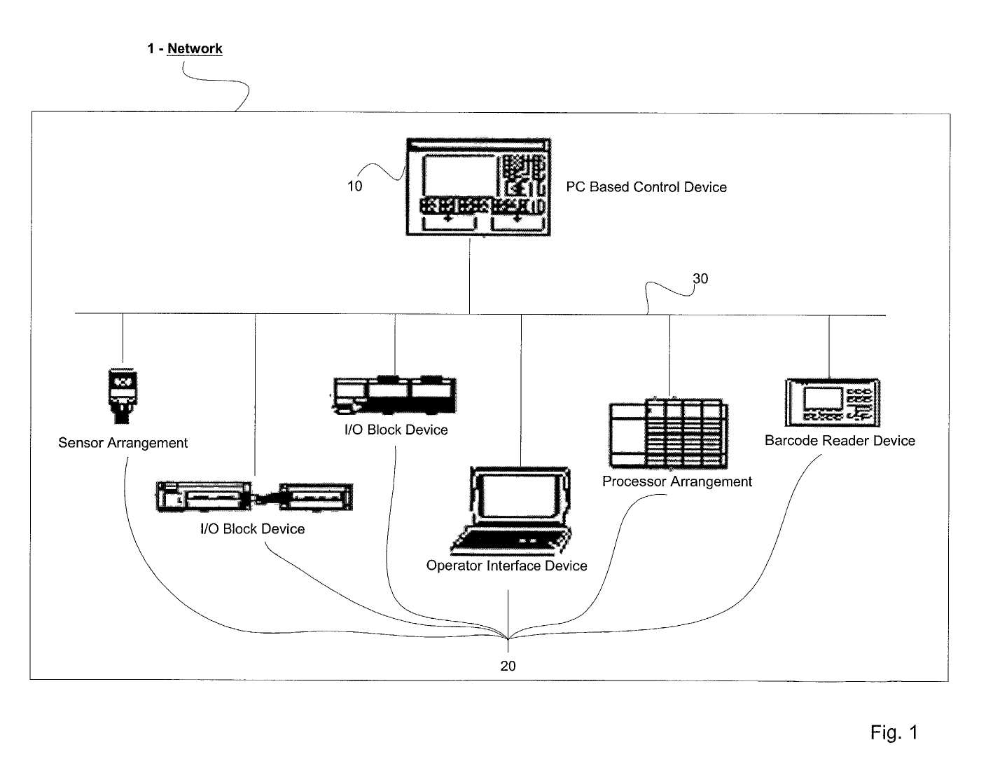

Those skilled in the art would understand that there are many types of networks in which a protocol may be implemented, for example, master-slave network or peer-to-peer network. In addition, the network may include a communication type such as multicast, change of state network, cyclical data production network, etc. Furthermore, a multi-master network may exist. FIG. 1 shows an exemplary network 1 which is a master-slave network. The network 1 may include a master device 10 (e.g., a PC based control device) and a plurality of slave devices 20 (e.g., I/O block devices, operator interface device, processor arrangement, sensor arrangement, barcode reader device, etc.), which communicate with each other via communication lines 30.

An embodiment according to the present invention discusses a system and method for developing a code generator for object-oriented communication protocols. The system comprises a code generation engine which automatically generates the necessary software code for communication between network devices as a function of network device profile data, network specification data and customized device data. The network 1 may also have a particular network specification which defines a communication protocol. As discussed above, the communication protocol provides specifications for the means by which the devices in the network 1 may communicate with one another. For example, the communication protocol may define the syntax and/or form of the data movement. The example described herein discusses a DeviceNet network, although those of skill in the art will understand other similar networks may also be used.

As depicted in FIG. 1, the network 1 has a plurality of network devices including a master device 10 and slave devices 20. Those skilled in the art will understand that a network 1 may comprise of one or more master devices and one or more slave devices. Each network device may adopt an object modeling approach, e.g., the information is structured in different objects. An object provides an abstract representation of a particular component within the device. Each device may contain a device profile, which may describe object characteristics.

Certain objects for a particular network device are required objects, while others may be optional objects. Each object may have certain required aspects including attributes, services, and behaviors. The developer may comply with all required aspects so that the corresponding device may be able to function within the network 1. In addition, the developer may take advantage of optional aspects to further enhance the functionality of the network device. Each of the objects may have several occurrences which further increase the number of objects which a developer may maintain. This creates multi-layers of complication for an object developer.

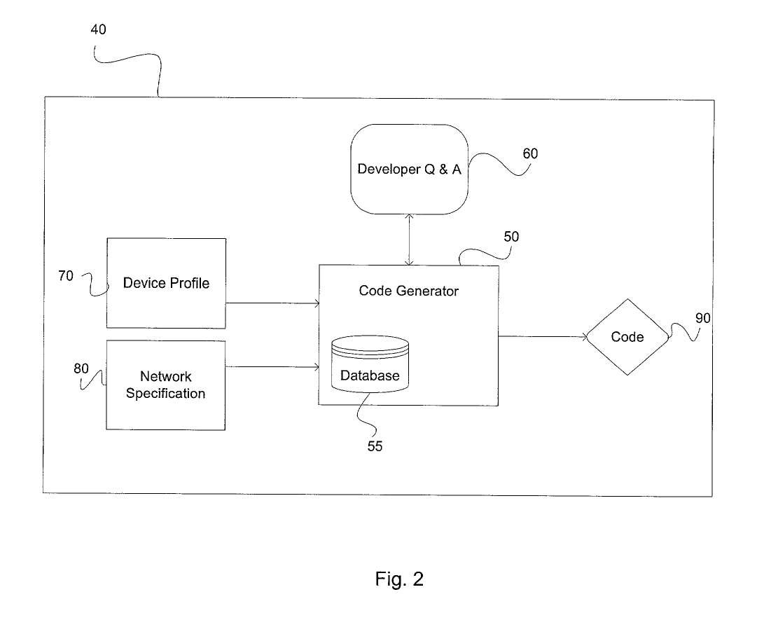

The embodiment according to the present invention provides a solution for this complication. Rather than the developer writing code for each object, its corresponding device profile, and each of its instances, the code generator creates a question-and-answer methodology for generating the necessary code for all objects and the corresponding linkage code generator. It provides the initial object selection and parameters based on the device profile and object definitions and allows further customization of the objects via a question and answer system 60 (“Q&A”). FIG. 2 shows an exemplary development environment 40. The code generator 50 may contain a database 55 that stores particular data. The database may be contained within the code generator 50, or may be elsewhere within the development environment 40, as is known in the art. The database 55 may hold data such as, for example, developer input, required objects, required attributes, data types, services, etc. The code generator 50 communicates with the developer through the Q&A system 60. The developer may be asked to specify which objects, optional attributes, data types, ranges, etc. are to be implemented for the particular device. The device profile 70 for each device and the network specifications may be utilized as source data for the code generator 50. The developer selects the relevant device profile 70 and customizes it through the Q&A system 60. With the information provided, the code generator 50 produces the necessary code 90 for the communication link between the devices.

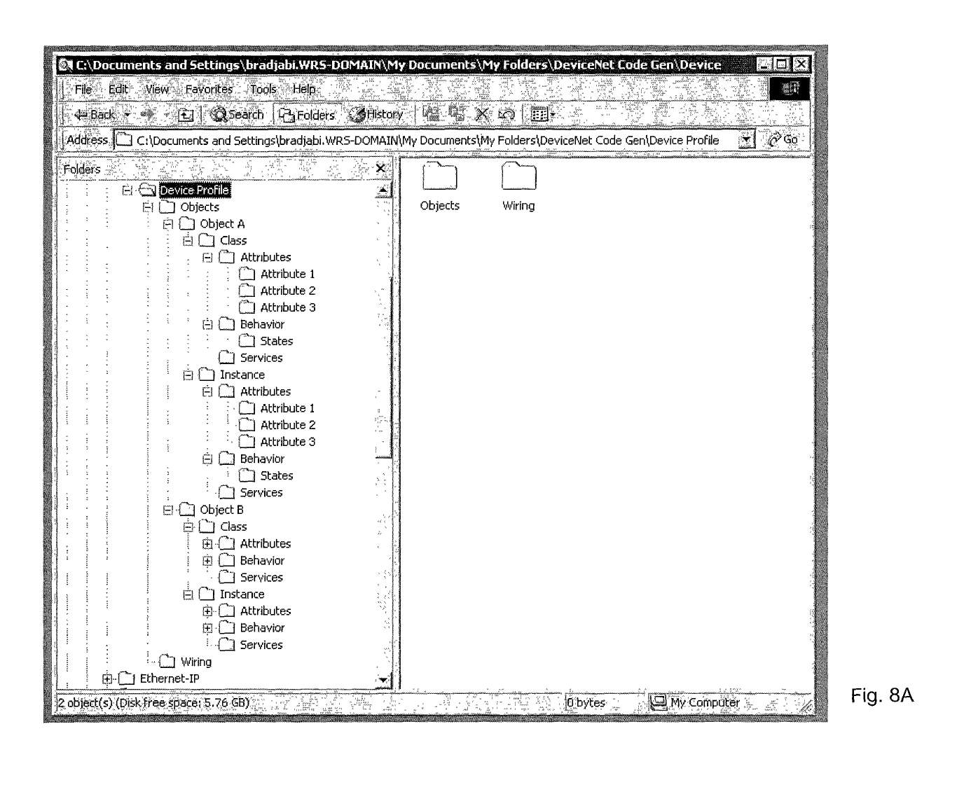

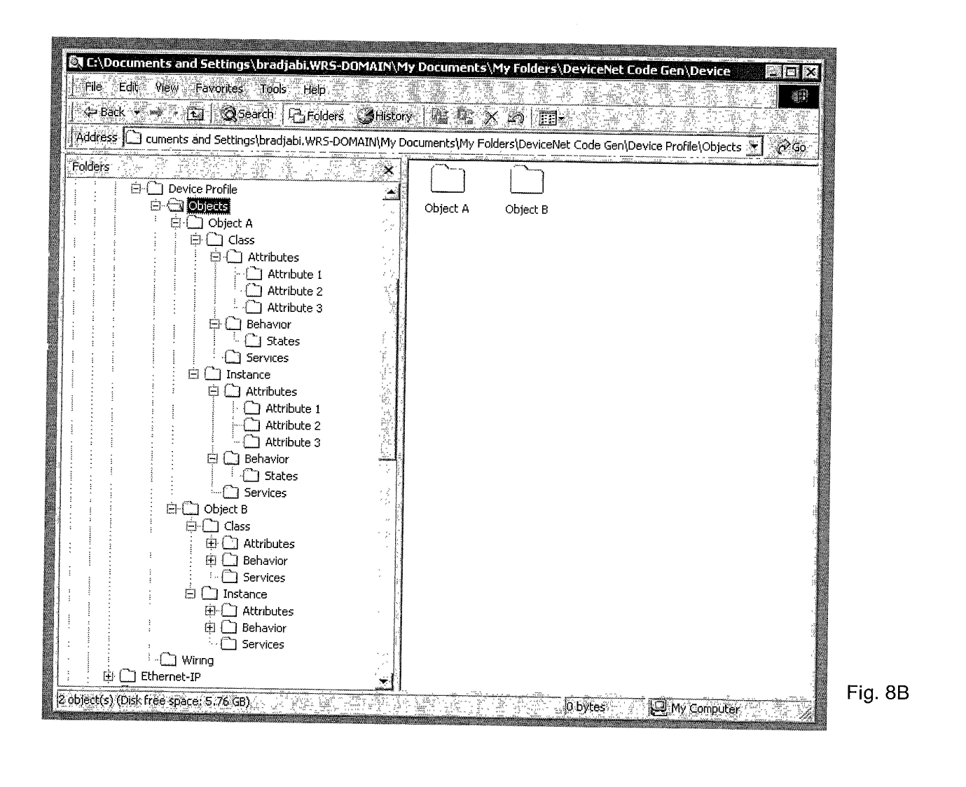

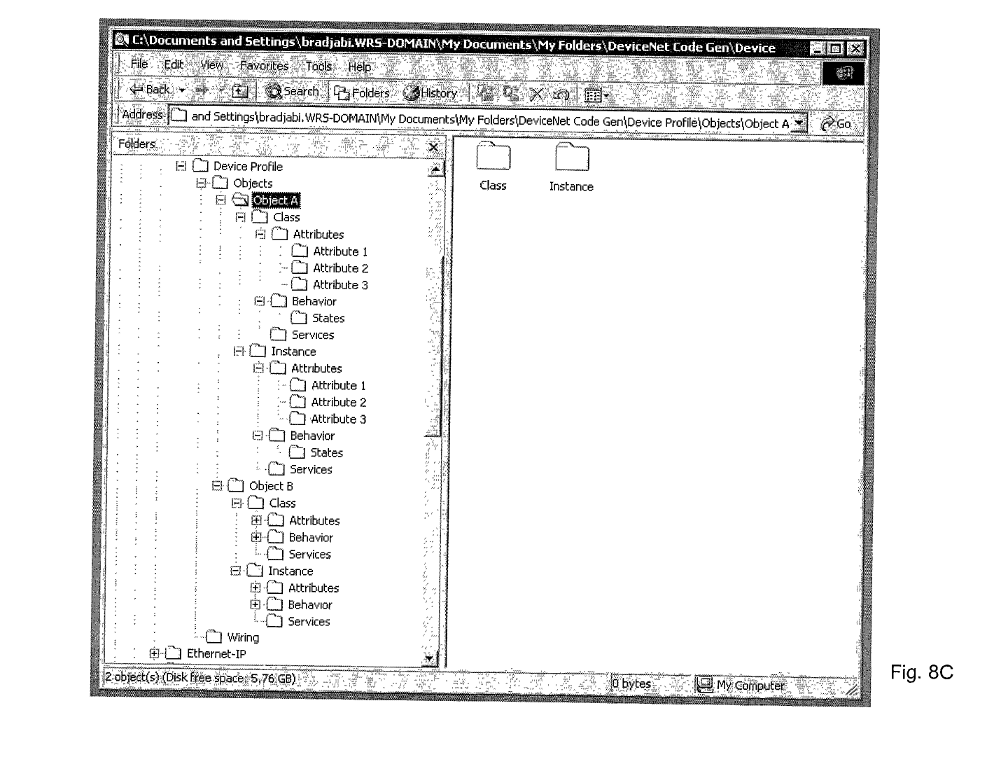

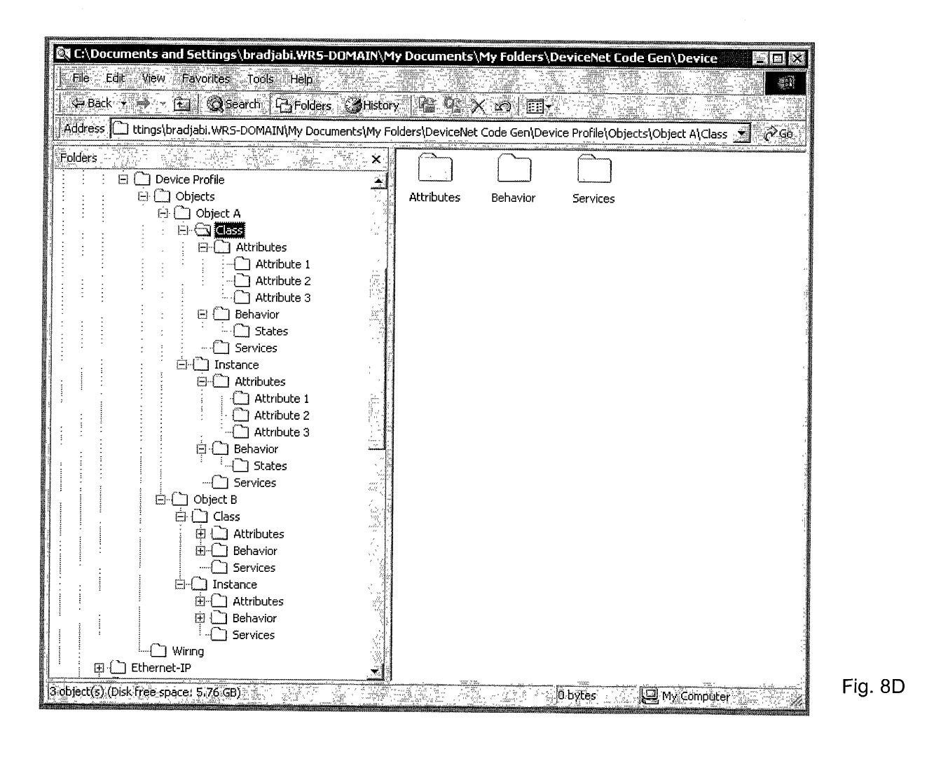

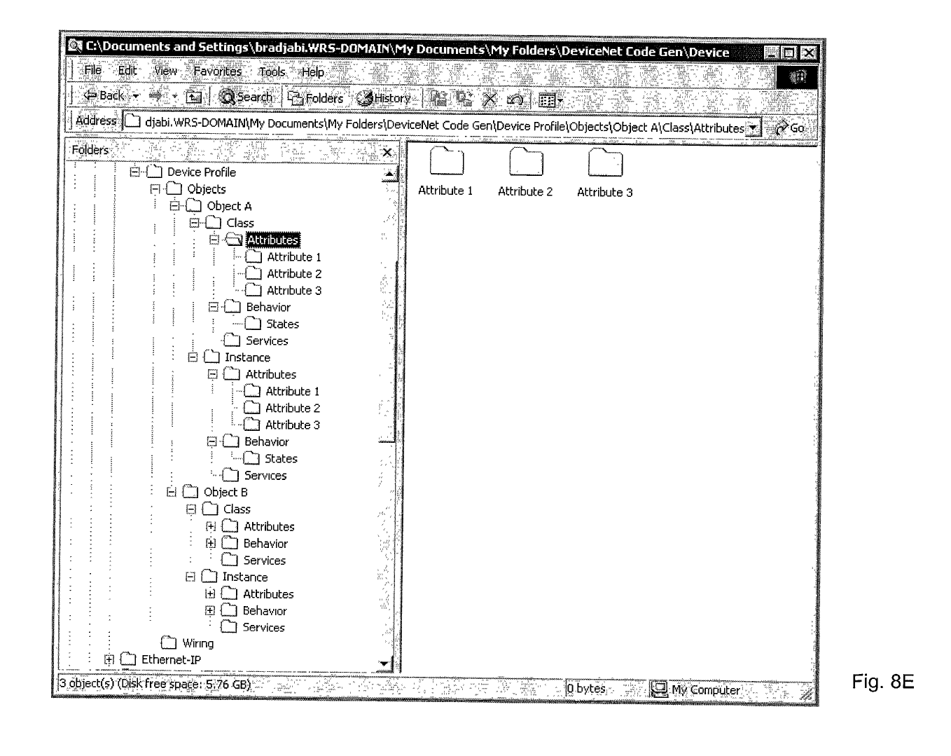

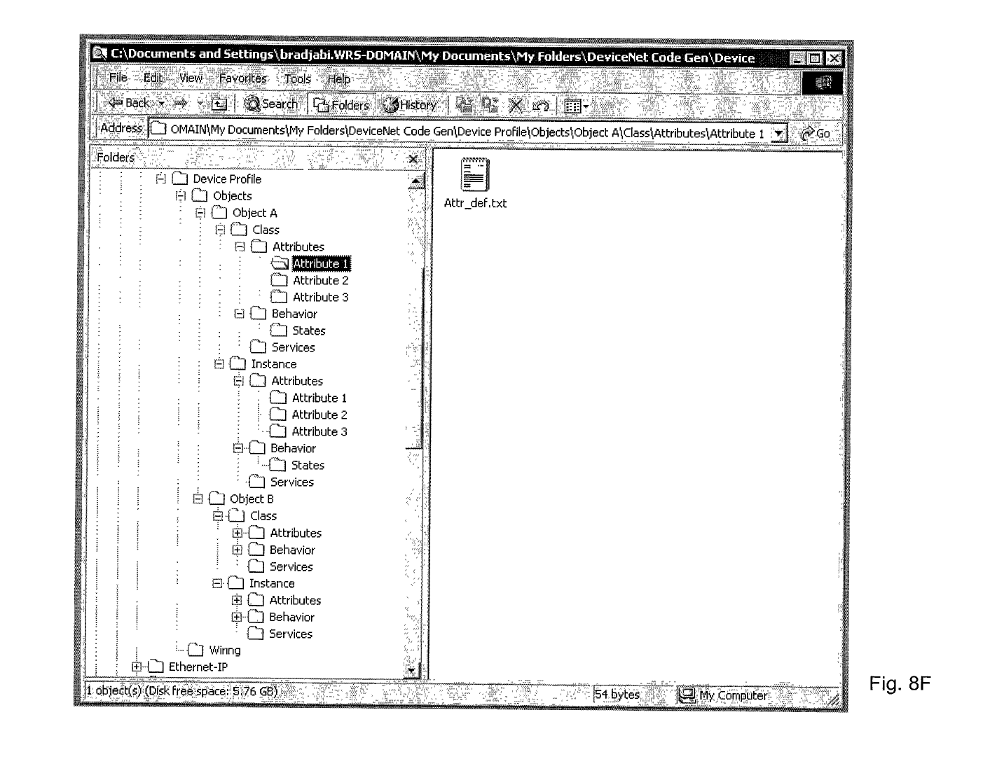

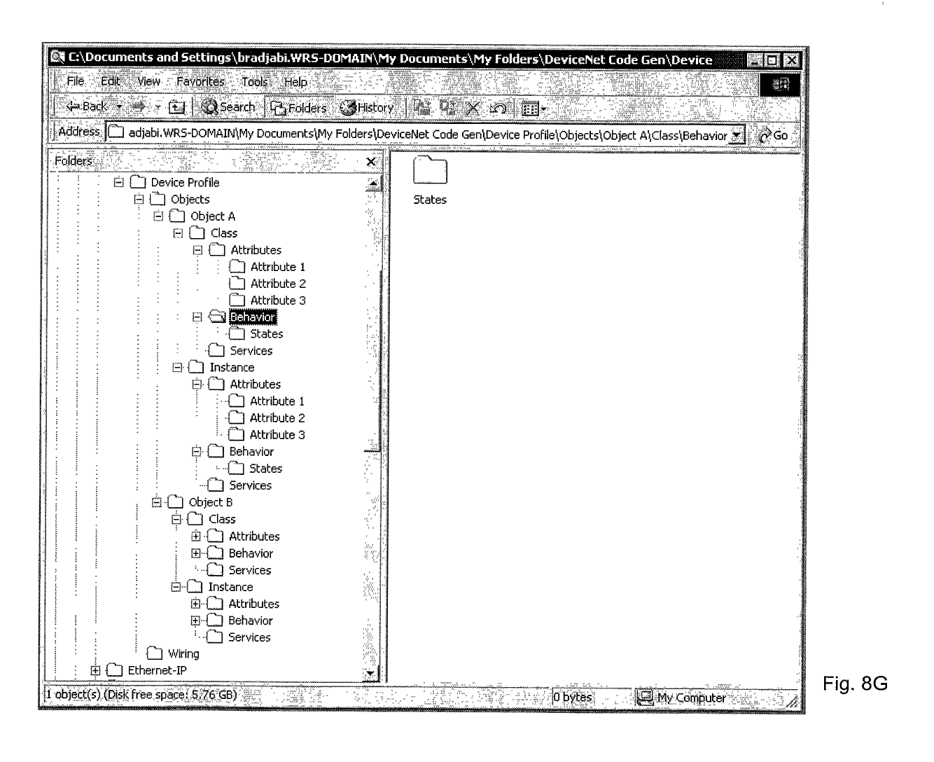

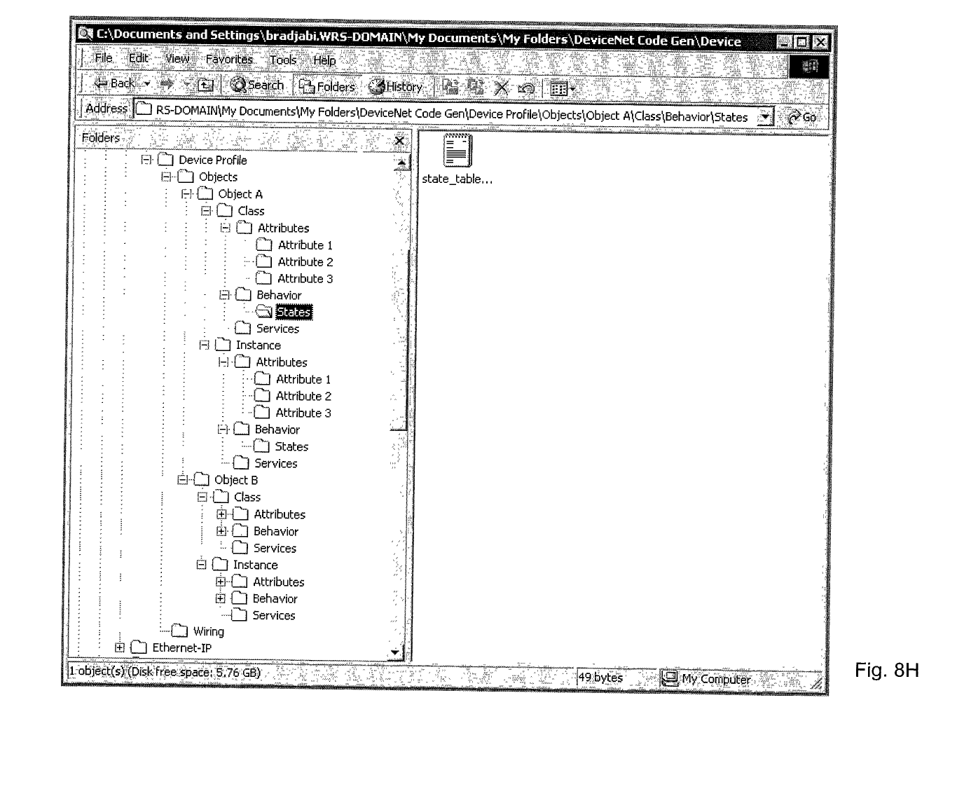

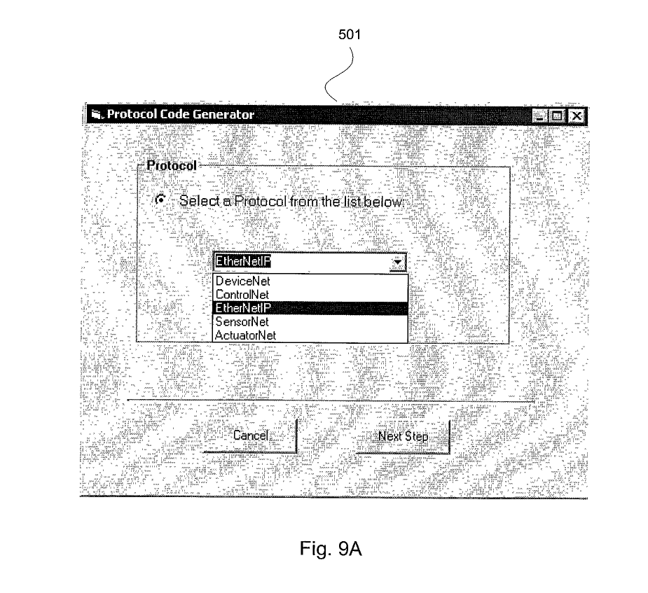

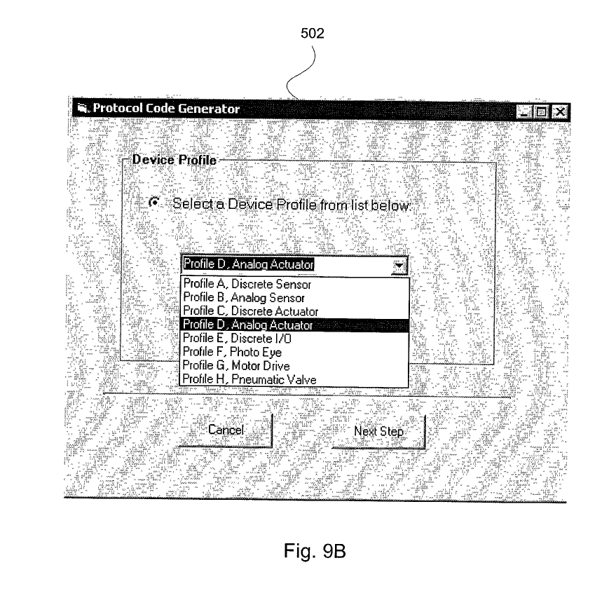

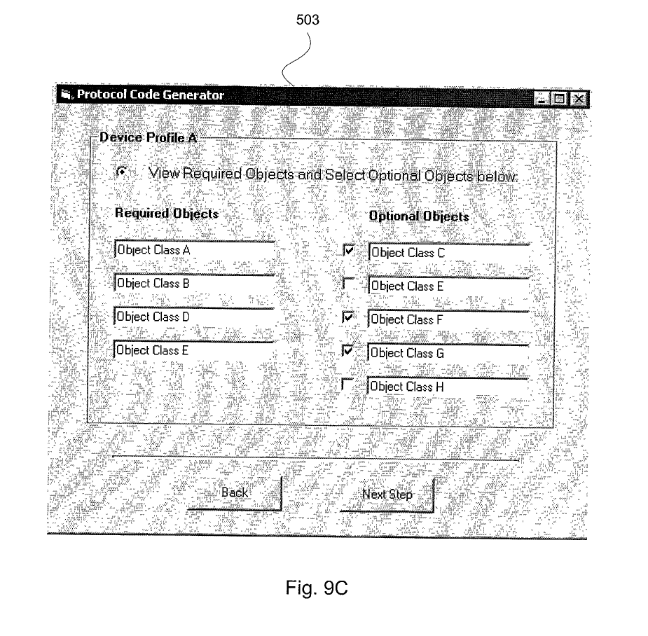

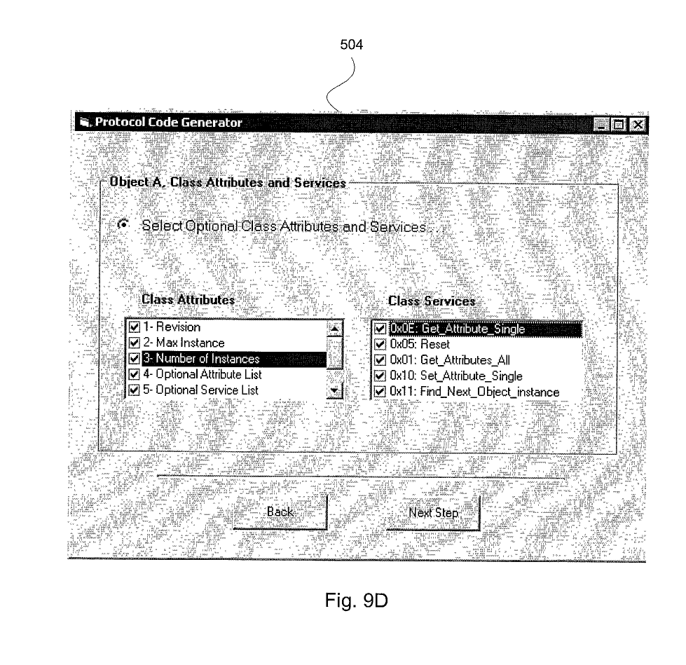

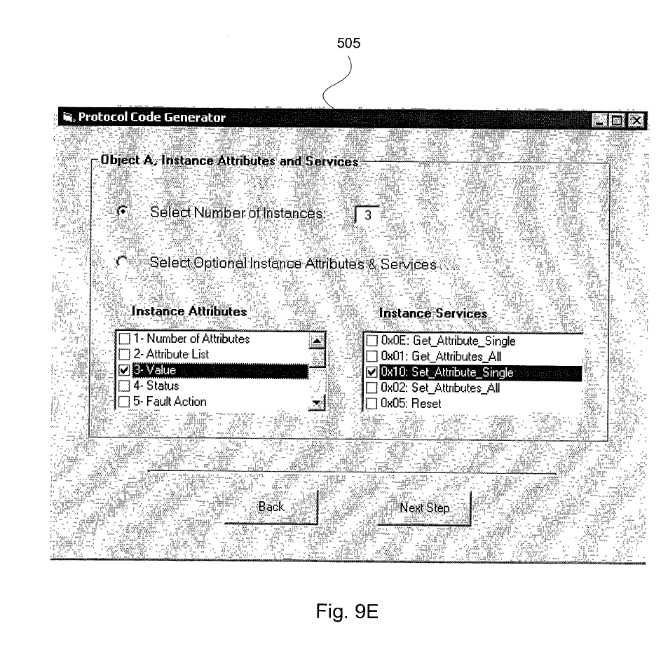

During the Q&A system 60, the developer may be asked a plurality of questions which define the parameters of the device profile 70. The code generator 50 may use the answers provided by the developer to structure the device profile 70 of a network device 20. Screen shots 501-505 in FIGS. 9A-E show exemplary screen shots of a Q&A system 60 that may be implemented. Screen shot 501 of FIG. 9A prompts the developer to select a protocol from a drop-down list containing options such as DeviceNet, ControlNet, EtherNetIP, SensorNet and ActuatorNet. Screen shot 502 of FIG. 9B prompts the developer to select a device profile from a drop-down list containing a plurality of profiles, such as, for example, Profile A, Discrete Sensor, Profile B, Analog Sensor, Profile C, Discrete Actuator, Profile D, Analog Actuator, Profile E, Discrete I/O, Profile F, Photo Eye, Profile G, Motor Drive, and Profile H, Pneumatic Valve. Screen shot 503 of FIG. 9C prompts the developer to review the required objects and choose any optional objects which may be desired. Screen shot 504 of FIG. 9D prompts the user to select the optional class attributes and services for the required Object A, selected in FIG. 9C. Screen shot 505 of FIG. 9E prompts the user to define the number of instances and the corresponding attribute(s) and service(s) for required Object A. In this manner, the developer may be able to create and organize the hierarchical arrangement (as shown in FIGS. 8A-8H) of the parameters of the device profiles for each network device 20 implementing the use of a graphical user interface (“GUI”). Once the parameters for the network device 20 are defined and the hierarchical directory tree is created, the developer may make changes to the device profile 70 easily. For example, the developer may open the folder corresponding to the device's Object Ox, Instance Iy, and Attribute Az, and edit the text file containing the attribute data.

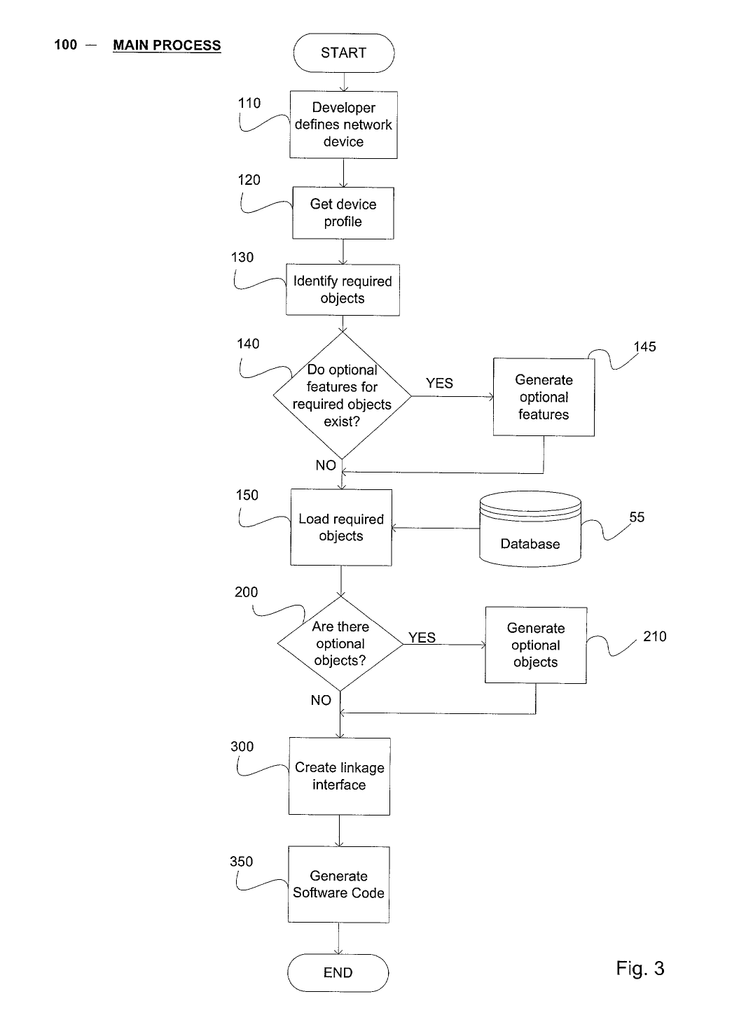

FIG. 3 shows an exemplary process 100 where the code generator 50 is utilized to generate the necessary code 90 for communication between the network devices 20. Those skilled in the art will understand that there are many processes that may be implemented to achieve the same procedure as represented in FIG. 3.

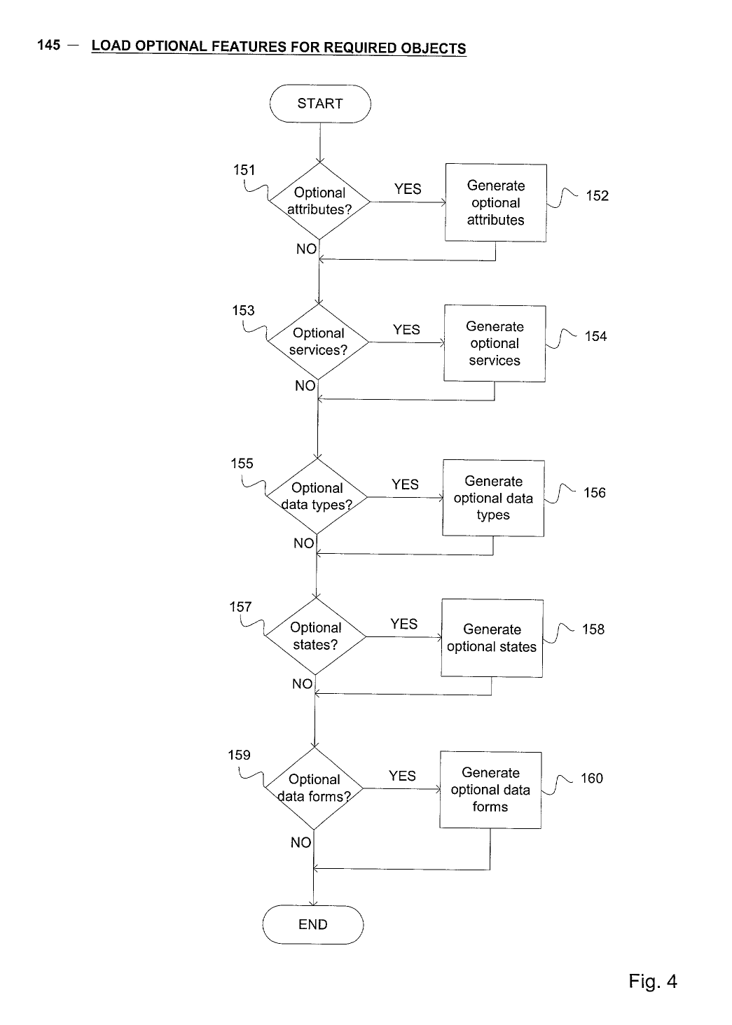

In step 110, the developer defines the network device 20 for which the code 90 is to be generated using the code generator 50 (for example, a DC motor). (See also FIG. 9B). The code generator 50 may then retrieve the corresponding device profile 70 (step 120) for the network device 20 (e.g., the device profile for a DC motor). The device profile 70 may describe the required objects and obtain aspects of each network device 20, as well as its functions. For example, a device profile 70 may contain the definition of the device's object model, the definition of the device's input/output (“I/O”) data format, and the definition of the device's configurable parameters and public interfaces to those parameters. Since the required objects for the network device 20 are predefined, in step 130, the required objects are identified to the developer (e.g., connection object, message router, identity, etc.). Required objects are specific to an individual device profile and thus may be different for various devices as is known in the art. The developer then is given the choice of defining optional features for the required objects through the Q&A system 60 (step 140). (See also FIG. 9C). If the developer chooses to define optional features, the features are loaded in step 145, which is discussed in more detail below and is shown in FIG. 4. The required objects are loaded in step 150 from the code generator database 55.

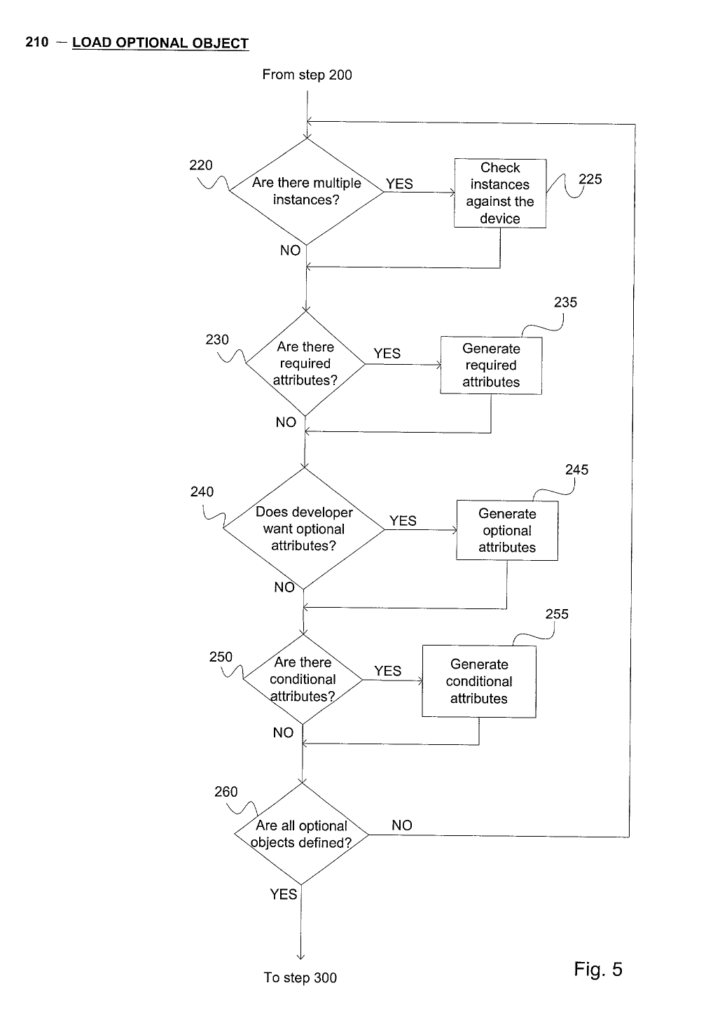

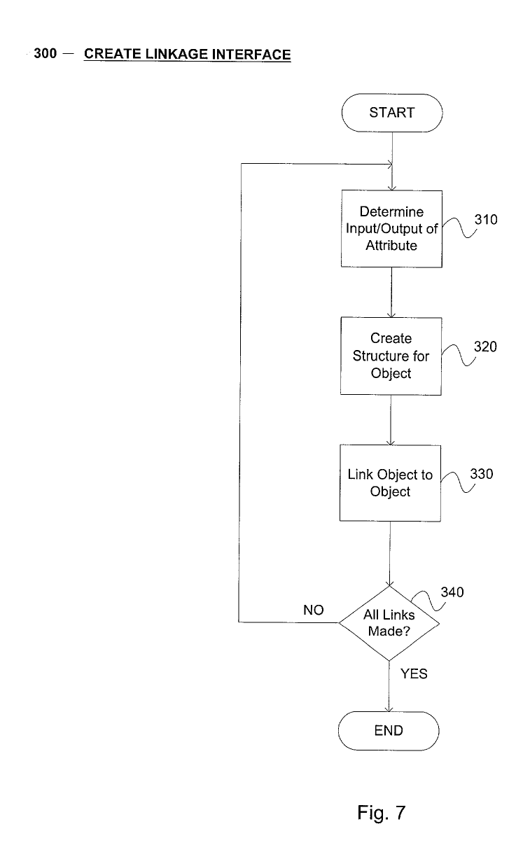

Next, the developer is asked to identify any optional objects that may exist (step 200). These optional objects, if any, are loaded in step 210, which is discussed in further detail below and is shown in FIG. 5. After all the necessary objects are loaded for the network device 20, a linkage interface is developed in step 300 which is discussed in further detail below and is shown in FIG. 7. Finally, the code 90 is automatically generated based on the required objects, optional objects, and the linkage interface to allow communication to and from the network devices 20.

An object may be defined with principal parameters such as attribute, service and behavior. A data type may be defined as a component of the attribute and a state may be defined to identify the object's behavior. The first parameter, the attribute, is characterized as required, optional, or conditional. As the terms suggest, a required attribute is an attribute that may be necessary, an optional attribute is one that may be included, and a conditional attribute is an attribute that is included if a particular predefined condition is satisfied. If the attribute is required or conditional, the code generator 50 automatically defines the parameter. The service parameter defines the access method for the corresponding object. The service may be required, e.g., may be necessary, or optional. If the service is an optional one, the developer is asked to define the service through the Q&A system 60. The behavior of the object may be described by defining the state of the object. The state of the object describes the status of the object, e.g., sleep, active, on/off, etc. Similar to the attributes parameter, the state may be required, optional, or conditional.

Some of the object's parameters (e.g., attributes, services, and behavior) are predefined for a required object. However, the developer may set optional features for the required objects, i.e., the developer may select optional features from a predefined list. FIG. 4 shows an exemplary process that a developer may follow when setting optional preferences. Those skilled in the art will understand that the preferred embodiment according to the present invention may be tailored to the developer's needs, and in such a way to accommodate many different types of developer-preferred settings that may be implemented. If the developer chooses to implement additional, optional features for the required objects defined in step 140 of FIG. 3, the developer is asked a series of questions using Q&A system 60 to determine which features the developer wishes to define (See FIG. 9D). For example, the developer may add optional attributes (step 151), optional services (step 153), optional data types (step 155), optional states (step 157) and/or optional data forms (step 159). In addition, the object may have additional vendor specific or developer-preferred features separate from the optional features described above.

In contrast to the predefined parameters for a required object, the developer is able to define the optional object's parameters. FIG. 5 shows an exemplary process for loading an optional object, depicted above in FIG. 3 as step 210. If the developer chooses to load optional objects for the network device 20, the developer may need to define the parameters for the object. First, the developer may need to indicate whether the optional object has multiple instances on the code generator 50 (step 220). (See also FIG. 9E). If so, the code generator 50 checks each of the instances against the device to determine if any conflicts exist (step 225).

If there are multiple instances of the object, the code generator 50 is able to simplify the necessary coding by duplicating the code 90 for each instance of the object with only a few, minor changes. For example, if there are five instances of the same optional object, but each object is connected to a different link (i.e., instance 1 to link 1, instance 2 to link 2, etc.), the code generator 50 replicates the code 90 for each instance of the object with the simple difference of changing the link number to the appropriate link. Therefore, the code 90 only has to be synthesized once for each of the instances.

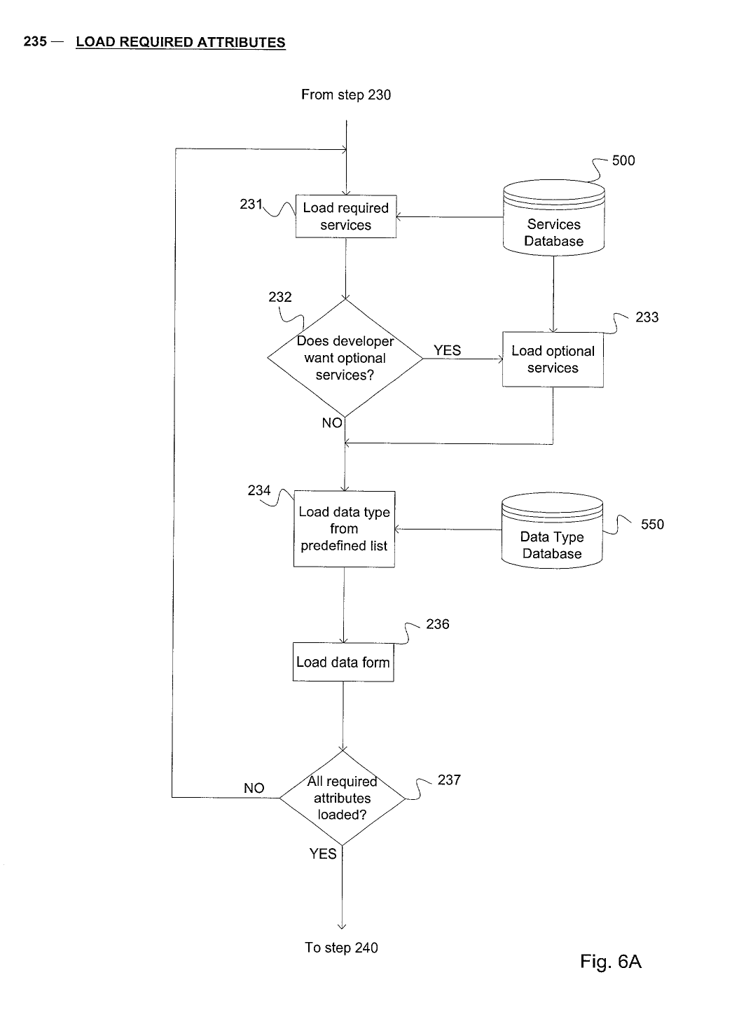

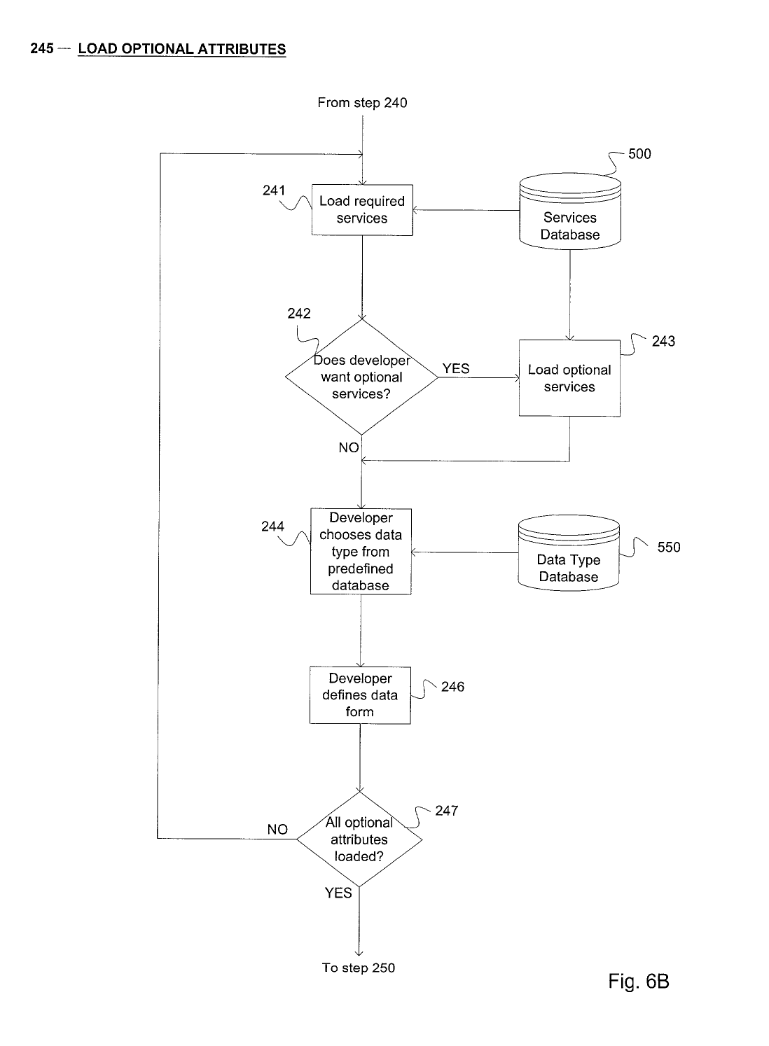

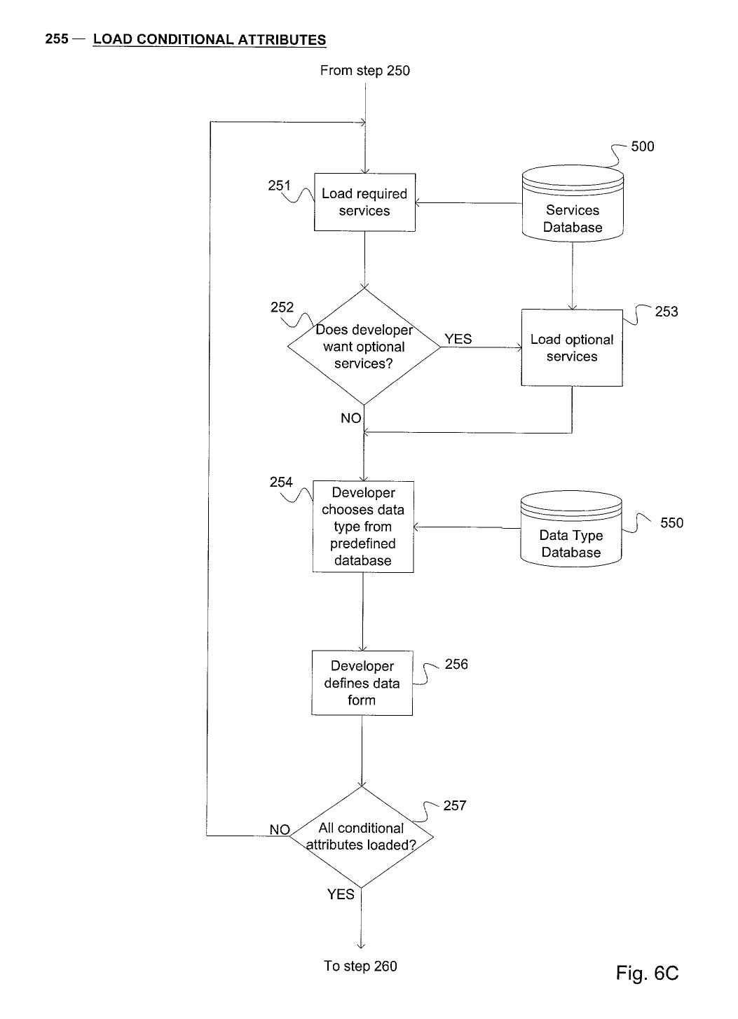

Next, in step 230, the code generator 50 determines if there are any required attributes for the optional object. If there are, all the required attributes are loaded in step 235, which is discussed in further detail below and is shown in FIG. 6A. In step 240, the developer is asked if there are any optional attributes. If optional attributes exist, they are loaded in step 245 which is discussed in further detail below and is shown in FIG. 6B.

In step 250, the code generator 50 determines if any conditional attributes need to be loaded. If they do, the generator 50 loads these conditional attributes in step 255. Since the conditional attributes are attributes that exist if certain conditions are satisfied, the developer does not have to input data in order for the code generator 50 to determine if certain conditions are met.

Finally, in step 260, the code generator 50 determines whether all the optional objects have been loaded through the above-described process. If there exist additional optional objects that have not been defined and loaded, the process repeats itself beginning from step 220 until all optional objects are defined at which point the process then comes to an end.

FIG. 6A shows an exemplary process for loading required attributes 235. Each required attribute has required services which are loaded in step 231 from the services database 500 which may be contained within the code generator database 55. The code generator database 55 may be an internally stored library that contains services that are available for the network 1. By having the service options pre-determined, the code generator 50 may easily produce corresponding portions of the necessary code 90 for the selected services without the developer manually writing it. The code generator database 55 is updated with any changes and/or additional services allowing the code generator 50 to run efficiently. For example, new services may be added by defining the service's influence on the object attributes. The required attribute may also have optional services in addition to the required services that were loaded in step 231. The developer is prompted to choose any optional services in step 232 which is loaded from the services database 500 (step 233). After the optional services are loaded or if the developer does not want to add any optional services, in step 234, the data type is loaded from a predefined list or data type database 550 of the code generator database 55. Since the attribute is required, the data form is automatically loaded in step 236. Finally, the code generator 50 checks if all required attributes have been loaded (step 237), and the process loops until all required attributes are defined for this particular object.

FIG. 6B shows an exemplary process for loading optional attributes 245. Each optional attribute has required services which are loaded in step 241 from the services database 500. The optional attribute may also have optional services in addition to the required services. The developer is prompted in step 232 to choose any optional services from a predefined list of choices. The developer's choice selection is then loaded from the services database 500 in step 243. If the developer chooses not to implement any optional services or after the developer has loaded the optional services, the developer is prompted in step 244 to select the data type from a predefined list of choices which is then loaded from a data type database 550. The developer defines the data type in step 246 by answering a sequence of questions 60 or by choosing from a list of options. The code generator 50 checks if all optional attributes have been loaded in step 247, and the process loops until all optional attributes are defined for this particular object.

FIG. 6C shows an exemplary process for loading conditional attributes 255. Each conditional attribute has required services which are loaded in step 251 from the services database 500. The conditional attribute may also have optional services in addition to the required services already defined. The developer may be prompted to choose any optional services from a predefined list of options in step 252. Any optional services that the developer desires is loaded in step 253 from the services database 500. Next, the developer chooses the data type from a predefined list of options in step 254, which is then loaded from the data type database 550. The developer then defines the data form in step 256. Finally, in step 257, the code generator 50 checks if all conditional attributes have been loaded, and the process loops until all optional attributes are defined for this particular object beginning from step 251.

A link is the line or channel over which data is transmitted. The link defines the ways in which a change in one object may influence a changes (or changes) in other objects. The link also defines how data is mapped from one object into another. The linkage between objects may be defined in the device profile.

FIG. 7 shows an exemplary process for creating the corresponding linkage interface for the network 1. First, in step 310, the code generator 50 determines for which object the linkage may be created. This may be done by determining which attribute does not have a defined input. Next, in step 320, the structure for the object is created, i.e., attribute, service and state machine. A state machine defines the behavior of the object based on the state table. Finally, objects are linked to each other in step 330. The code generator 50 verifies if all links have been made in step 340, and if one or more have not been made, the process repeats from step 310 until all have been made.

FIGS. 8A-8H show exemplary graphical user interface (“GUI”) for describing a directory tree representing structure of a device profile 70 and the associated objects. The following is a description of the GUI which show a device profile 70 which has already been created for a particular network device 20. The GUI shows each object's parameters in a hierarchical arrangement. The root directory is the folder for the device profile 70 (“directory” and “folder” will be used interchangeably herein). Within this directory, there are two subdirectories, objects and wiring. The objects folder contains a subdirectory for each object defined in the device profile. For example, as shown in FIG. 8B, the device profile 70 has two objects, Object A and Object B. Each object has a class and instance subdirectory. The class subdirectory contains attributes, behavior, and services subfolders. It should be clear that each subdirectory is associated with the directory directly above and below it. For example, the highlighted Class parameter in FIG. 8D and the Instance parameter are associated because they are situated directly underneath and in the first level of offset from Object A. For example, in FIG. 8E, the attributes folder has three attributes, i.e., Attribute 1, Attribute 2 and Attribute 3. Each attribute subdirectory will contain the relevant information in a file such as, for example, a text file. Similarly, the rest of the directories are parent directories of those directories which are a level below them in FIGS. 8A-8H as is known in the art. Those skilled in the art will also understand that the directory tree depicted in FIGS. 8A-8H are exemplary and that there are a plurality of hierarchical structures that may be used to file the structure and associated objects of the device profile 70.

An advantage of the preferred embodiment according to the present invention is that it simplifies the development of object-oriented communication protocol. The present invention allows a novice developer to create necessary code based on a description of the desired device and allows an experienced developer to create necessary code quickly and accurately. Furthermore, developers may easily change the networking and communication linkage between network devices 20 by using the preferred embodiment.

Another advantage of the preferred embodiment according to the present invention is that it reduces the possibility of error through the use of an automated code generator. The code generator is able to generate the necessary code while examining and complying with required rules.

Another advantage of the preferred embodiment according to the present invention is that instead of creating a separate set of code for each instance of the same object, the present invention checks each instance against the code generator to ensure that multiple instances are allowable and generates the necessary code without developer response redundancy. In this way, the preferred embodiment reduces the coding process and the amount of code necessary. Moreover, the process that the preferred embodiment implements constructs a simplified method of organizing and structuring the code for the network communication protocol.

In the preceding specification, the present invention has been described with reference to specific exemplary embodiments thereof. It will, however, be evident that various modifications and changes may be made there unto without departing from the broadest spirit and scope of the invention as set forth in the appended claims. The specification and drawings are, therefore, to be regarded in an illustrative rather than restrictive sense.

What is claimed is:

1. A system, comprising:
a database containing device profile data and network specification data; and
a code generation engine configured to automatically generate software code for a network device as a function of the device profile data, the network specification data and customized device data.

2. The system of claim 1, further comprising:
a graphical user interface, wherein the customized device data is received via the graphical user interface.

3. The system of claim 1, wherein the device profile data defines device objects, optional features, functions and a device linkage interface.

4. The system of claim 3, wherein the software code includes a first code and a second code, the code generation engine being configured to generate the first code for the device objects and the second code for the device linkage interface.

5. The system of claim 1, wherein the device profile data and the network specification data conform to the DeviceNet specification.

6. The system of claim 4, wherein the device objects include required objects.

7. The system of claim 6, wherein the device objects further include optional objects.

8. The system of claim 6, wherein the customized device data includes optional features of the required object, the optional features being provided via a graphical user interface.

9. The system of claim 8, wherein the optional features include optional attributes, optional services, optional data types, optional states and optional data forms.

10. The system of claim 7, wherein the optional objects include at least one of required attributes, optional attributes and conditional attributes.

11. The system of claim 2, wherein the graphical user interface includes a question and answer system.

12. The system of claim 2, wherein the graphical user interface includes a hierarchal tree representation.

13. The system of claim 1, wherein a portion of the device profile data is selectable via the graphical user interface.

14. A method, comprising the steps of:
receiving customized device data for a first device of a network;
generating a first software code for device objects of the first device and a second software code for a device linkage interface, each as a function of device profile data, network specification data and the customized device data; and
automatically generating a software code using the first and second software codes to allow communications between the first device and a second device of the network.

15. The method of claim 14, further comprising the step of:
displaying a graphical user interface, wherein the receiving step is performed using the graphical user interface.

16. The method of claim 14, wherein the device objects include required objects.

17. The method of claim 16, wherein the device objects further include optional objects.

18. The method of claim 14, wherein the customized device data includes optional features of the required object.

19. The method of claim 14, further comprising the step of:
retrieving the device profile data and the network specification data from a database.

20. The method of claim 18, wherein the optional features include optional attributes, optional services, optional data types, optional states and optional data forms.

21. The method of claim 16, wherein the optional objects include at least one of required attributes, optional attributes and conditional attributes.

22. The method of claim 15, wherein the graphical user interface includes a hierarchical tree representation.

23. The method of claim 14, further comprising the steps of:
receiving a selection of the device profile data, and using the selection to perform the retrieving of the device profile data.

24. The method of claim 15, wherein the receiving step is performed by displaying questions related to the customizing device data and receiving answers related to the customized device data.

25. The method of claim 14, wherein the device profile data and the network specification data conform to the DeviceNet specification.
